(19) United States
(12) Patent Application Publication
(10) Pub. No.: US 2001/0014240 A1
(43) Pub. Date: Aug. 16, 2001

(54) KEYBOARD APPARATUS

(76) Inventors: MASAAKI KAGEYAMA, FUKUSHIMA-KEN (JP); SHOUJI SUGANAMI, FUKUSHIMA-KEN (JP); SIICHI SUGA, FUKUSHIMA-KEN (JP); TSUYOSHI NARUSAWA, FUKUSHIMA-KEN (JP); TERUYASU FUKUYAMA, FUKUSHIMA-KEN (JP)

Correspondence Address: BRINKS HOFER GILSON & LIONE, P.O. BOX 10395, CHICAGO, IL, 60610, US

(21) Appl. No.: 09/283,683

(22) Filed: Apr. 1, 1999

(30) Foreign Application Priority Data
Apr. 2, 1998 (JP) 10-090005

(51) Int. Cl. B41J 5/08; B41J 5/16

(52) U.S. Cl. 400/496

(57) ABSTRACT

A keyboard apparatus permits easier installation of slide retaining pins to a retaining portion and prevents intrusion of dust into the keyboard apparatus from the back surface of a supporting substrate thereof. A first retaining portion has a narrow area and a wide area, and slide retaining pins are latched in the wide area. A dust-proof sheet is provided on the bottom surface of a supporting substrate to cover through holes in the supporting substrate, the through holes resulting from the formation of the first retaining portion and second retaining portions.

### BACKGROUND OF THE INVENTION

1. Field of the Invention

The present invention relates to a keyboard apparatus ideally used for a personal computer of a notebook type or the like for which thinness is required.

2. Description of the Related Art

A conventional keyboard apparatus will be described in conjunction with the accompanying drawings. FIG. 6 is a partial sectional view of the conventional keyboard apparatus, and FIG. 7 is a sectional view taken at the line 7-7 of FIG. 6. FIG. 8 is a schematic representation of a supporting substrate used for the conventional keyboard apparatus, wherein FIG. 8A is a partial top plan view of the supporting substrate, and FIG. 8B is a sectional view taken at the line 8B-8B of FIG. 8A.

A plate-like supporting substrate 51 made of a metal has: a pair of rectangular slits 51a and two pairs of rectangular slits 51b provided in parallel; a first retaining portion 51c which is positioned between the paired slits 51a, provided by cutting and raising a square wall so that it protrudes upward, and has a trapezoidal section; two second retaining portions 51d, each of which is positioned between the slits 51b of each pair, provided by cutting raising square walls so that they protrude upward, and have U-shaped sections; and vertical through holes 51e formed by providing the slits 51a and 51b, the first retaining portion 51c, and the second retaining portions 51d.

The single first retaining portion 51c and the two second retaining portions 51d are disposed triangularly on the supporting substrate 51. A plurality of sets, each set consisting of the three retaining portions, are formed on the supporting substrate 51.

A contact sheet 52 composed of two layers of flexible resinous films (not shown) has printed contacts on two opposing surfaces of the resinous films disposed with a predetermined gap provided therebetween. The sheet 52 has a plurality of apertures 52a. The first retaining portion 51c and the second retaining portions 51d are mounted on the supporting substrate 51, being inserted in the respective apertures 52a.

A link assembly L formed of a synthetic resin is constituted by a first supporting member 53 and a second supporting member 54. The first supporting member 53 is composed of: a plate-like base 53a; a round aperture 53b provided at the center of the base 53a; pivot shafts 53c installed on both sides at the center of the base 53a; a rotary shaft 53d which is provided about the pivot shafts 53c and which projects from the sidewall of one end of the base 53a; a pair of arms 53e which are provided around the pivot shaft 53c, coupled to the base 53a on the opposite side thereof, and protrude in parallel to each other; and slide retaining pins 53f provided so that they protrude inward with respect to the ends of the arms 53e.

The second supporting member 54 is constituted by a base 54a, a pair of arms 54b which are formed approximately in a U shape by being coupled to the base 54a and which are provided in parallel to each other, a slide pin 54c provided in such a manner that it protrudes outward on the free end of each of the arms 54b; a pair of pivot apertures 54d provided at the middle of each of the arms 54b such that they face each other; and a T-shaped rotary retaining pin 54e which is coupled to the base 54a and extends in the opposite direction from the arms 54b.

The first supporting member 53 and the second supporting member 54 are connected by the pivot shafts 53c that are fitted from inside into the pivot apertures 54d so that they intersect with each other. The slide retaining pin 53f is slidably retained in the single first retaining portion 51c, and the rotary retaining pin 54e is rotatably retained and held in the two second retaining portions 51d, thus configuring a set retaining portions of the link assembly L.

A key top 55 composed of a molding made of a synthetic resin has supporting portions 55a and 55b on the bottom surface thereof. The rotary shaft 53d of the first supporting member 53 and the slide pin 54c of the second supporting member 54 are retained by the supporting portions 55a and 55b, respectively.

A rubber spring 56 formed of a rubber constituent is constructed of a dome portion 56a that has a section shaped like an inverted U and a flat top surface, a cylindrical contact portion 56b provided on the top of the dome portion 56a, and a protuberance 56c provided so that it protrudes downward in the dome portion 56a. The bottom of the dome portion 56a of the rubber spring 56 is fixed onto the sheet 52 by an appropriate means, and the dome portion 56a is inserted in the round aperture 53b of the first supporting member 53 so that the contact portion 56b comes in contact with the bottom surface of the key top 55. The springiness of the dome portion 56a urges the link assembly L and the key top 55 upward at all times. At this time, the protuberance 56c provided on the dome portion 56a is positioned above the sheet 52.

A plurality of the link assemblies L, the key tops 55, the rubber springs 56 configured as discussed above are arranged on the supporting substrate 51 and the sheet 52 to make up the keyboard apparatus. This keyboard apparatus is installed on a personal computer or the like. In using the personal computer, when the key top 55 is pressed downward against the springiness of the rubber spring 56, the link assembly L moves down with the intersecting point as its center. At this time, the slide retaining pin 53f slides in the first retaining portion 51c, while the slide pin 54c slides in the supporting portion 55b, causing the link assembly L to be collapsed. This squeezes and deforms the dome portion 56a, causing the protuberance 56c to push the contact sheet 52. The pushing force turns ON the contact provided on the sheet 52, so that the input signal of the key is transmitted to a control member (not shown) of the personal computer or the like. The moment the key top 55 is released, the deformed dome portion 56a resets itself by its own springiness, the link assembly L and the key top 55 accordingly restore their original conditions, and the contact of the sheet 52 turns OFF. In this way, the contact is turned ON/OFF.

In the process for assembling the conventional keyboard apparatus described above, to dispose the slide retaining pin 53f such that it is held by the first retaining portion 51c, the arms 53e of the first supporting member 53 are flexibly spread outward to insert them into the first retaining portion 51c to hold them therein. Similarly, in order to dispose the rotary retaining pin 54e so that it is held in the second retaining portion 51d, the arms 54b of the second supporting members 54 are flexed inward to insert them into the second retaining portions 51d to hold them therein.

The first retaining portion 51c, however, has the following disadvantage because of its square shape. In the assembly process of the conventional keyboard apparatus, the two arms 53e provided with the slide retaining pins 53f have to be flexed to insert them into the first retaining portion 51c as described above, resulting in poor assemblability.

Further, the slits 51a and 51b are formed in the supporting substrate 51, then the wall between the slits are cut and raised to form the first retaining portion 51c and the second retaining portions 51d. As a result, the through holes 51e are formed in the supporting substrate 51 as mentioned above. Dust intrudes into the keyboard apparatus from the back face of the supporting substrate 51, adversely affecting the operation or the like of the link assembly L.

### SUMMARY OF THE INVENTION

Accordingly, the present invention has been made with a view toward solving the problems described above, and it is an object thereof to provide a keyboard apparatus which permits improved assemblability and which inhibits dust from entering through the back face of a supporting substrate of the keyboard apparatus.

To this end, according to one aspect of the present invention, there is provided a keyboard apparatus equipped with a supporting substrate having a retaining portion provided by cutting and raising such that it protrudes upward, and a vertical through hole resulting from the cutting and raising; wherein the bottom surface of the supporting substrate is provided with a dust-proof sheet to cover the through hole.

According to another aspect of the present invention, there is provided a keyboard apparatus equipped with a supporting substrate having a retaining portion provided by cutting and raising such that it protrudes upward, a vertical through hole formed by the cutting and raising; and a supporting member having a pair of slide retaining pins which are latched on the retaining portion and which protrude, opposing each other; wherein the retaining portion has a narrow area and a wide area, and the slide retaining pins are latched in the wide area of the retaining portion.

In a preferred form of the keyboard apparatus in accordance with the present invention, the narrow area of the retaining portion is formed to be narrower than the interval between the slide retaining pins, while the wide area of the retaining portion is formed to be wider than the interval between the slide retaining pins.

In another preferred form of the keyboard apparatus in accordance with the present invention, the bottom surface of the supporting substrate is provided with a dust-proof sheet to cover the hole.

### BRIEF DESCRIPTION OF THE DRAWINGS

FIG. 1 is a sectional view of a keyboard apparatus in accordance with the present invention;

FIG. 2 is a schematic representation of a supporting substrate used for the keyboard apparatus in accordance with the present invention;

FIG. 3 is a schematic representation of the operation of the keyboard apparatus in accordance with the present invention;

FIG. 4 is a sectional view taken at the line 4-4 of FIG. 3;

FIG. 5 is a schematic representation illustrative of the assembly steps of the keyboard apparatus in accordance with the present invention;

FIG. 6 is a partial sectional view of a conventional keyboard apparatus;

FIG. 7 is a sectional view taken at the line 7-7 of FIG. 6; and

FIG. 8 is a schematic representation of a supporting substrate used for the conventional keyboard apparatus.

### DESCRIPTION OF THE PREFERRED EMBODIMENT

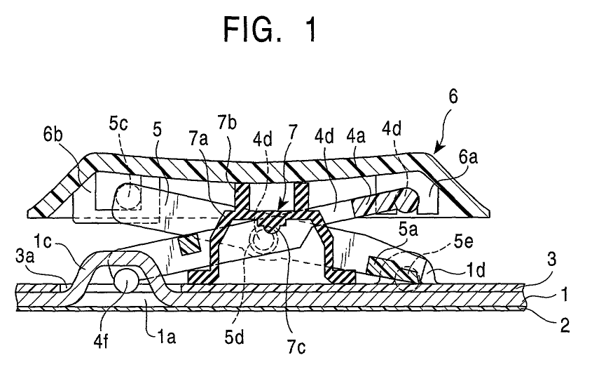

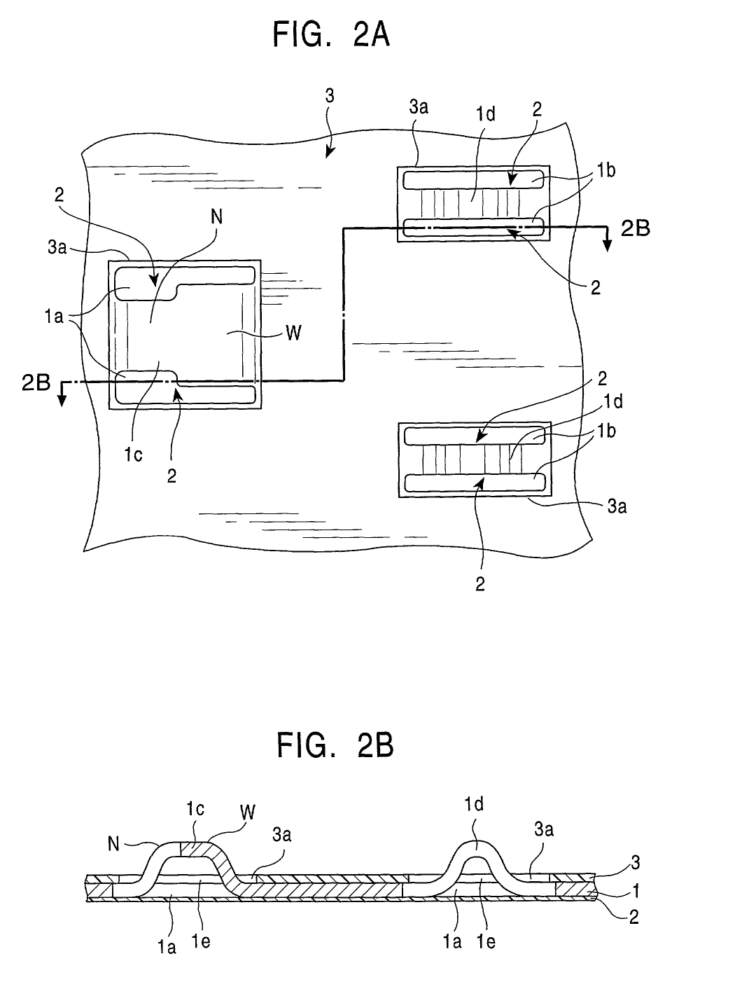

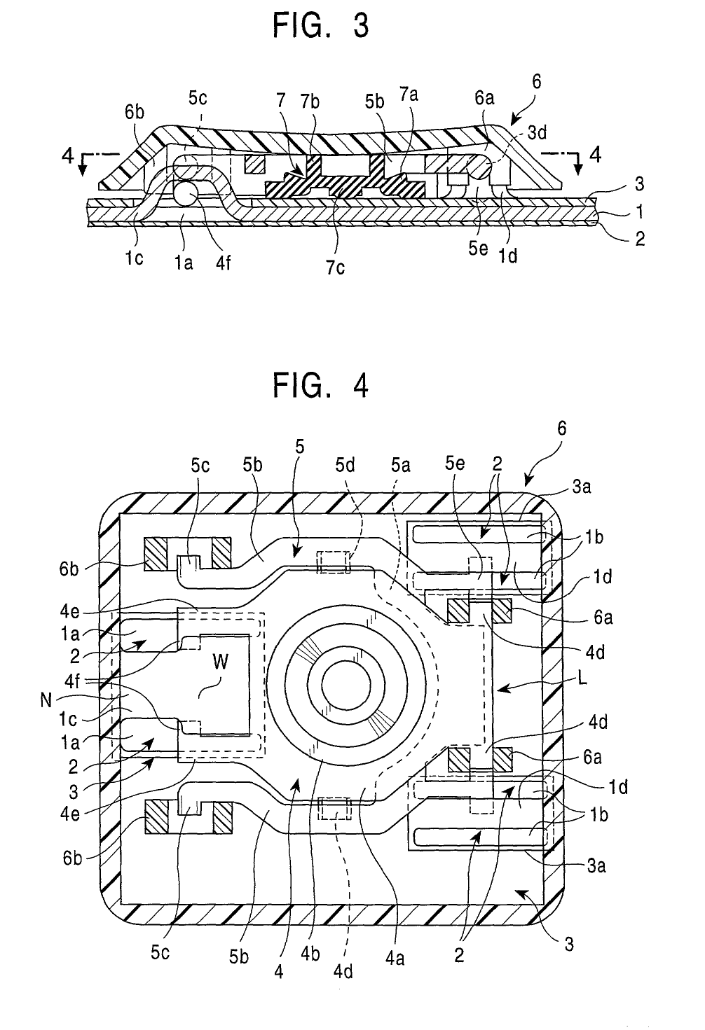

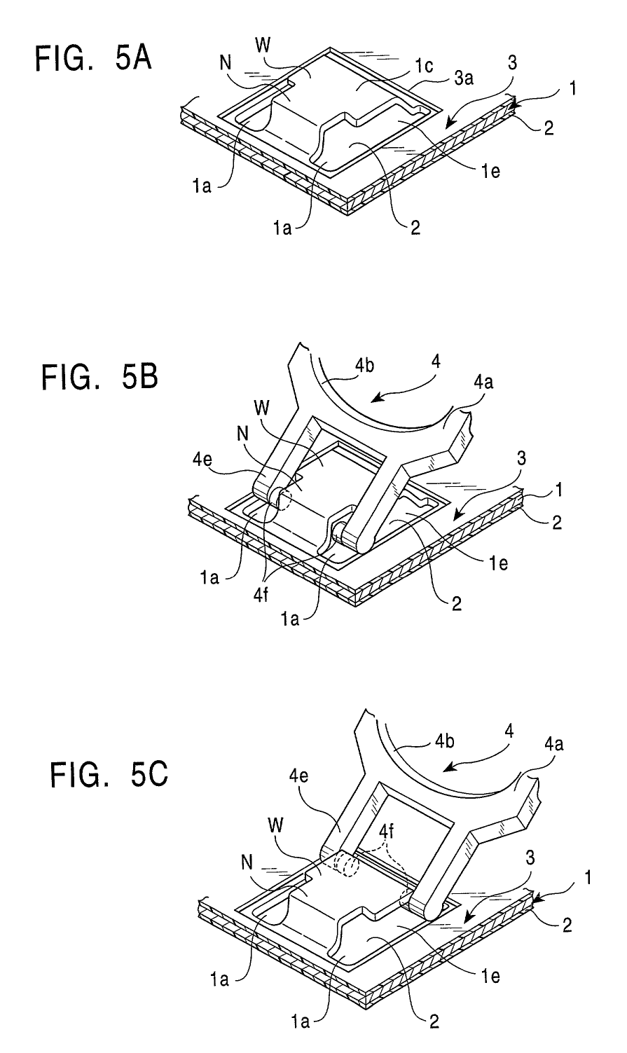

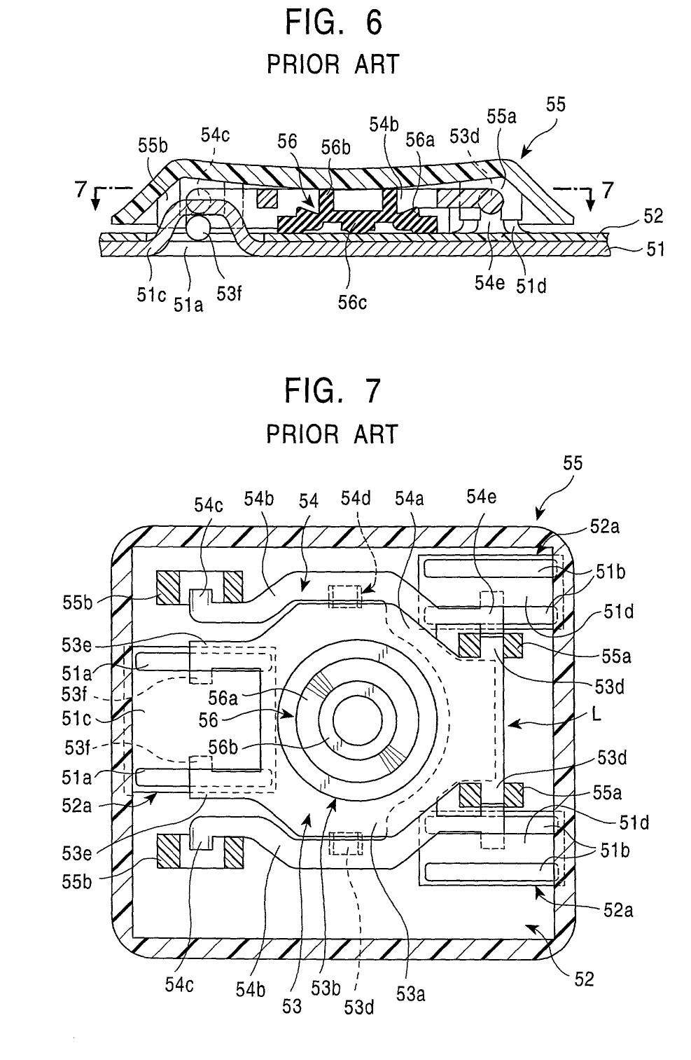

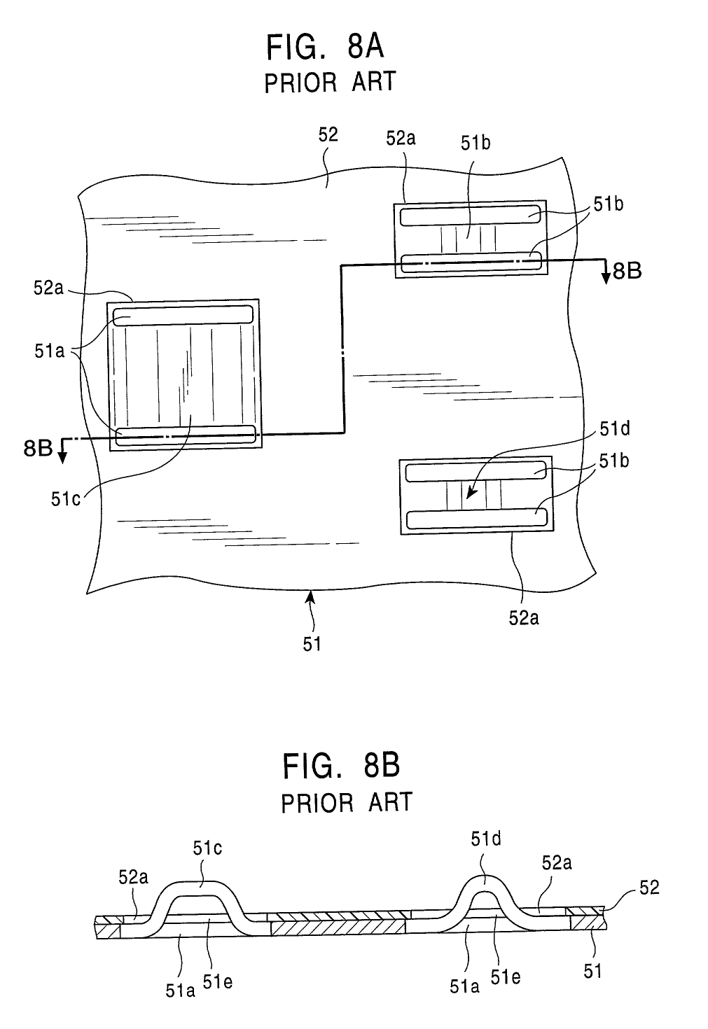

An embodiment of the keyboard apparatus in accordance with the present invention will be described in conjunction with the accompanying drawings. FIG. 1 is a sectional view of the keyboard apparatus in accordance with the present invention. FIG. 2 is a schematic representation of a supporting substrate used for the keyboard apparatus in accordance with the present invention, wherein FIG. 2A is a partial top plan view of the supporting substrate, and FIG. 2B is a sectional view taken at the line 2B-2B of FIG. 2A. FIG. 3 is a schematic representation illustrative of the operation of the keyboard apparatus in accordance with the present invention. FIG. 4 is a sectional view taken at the line 4-4 of FIG. 3. FIG. 5 is a schematic representation illustrative of the assembly steps of the keyboard apparatus in accordance with the present invention.

A plate-like supporting substrate 1 formed of a metal constituent has: a pair of L-shaped slits la provided in parallel and two pairs of rectangular slits 1b provided in parallel; a first retaining portion 1c which is positioned between the paired slits 1a, provided by cutting and raising a portion of the plate such that it has areas of different widths and protrudes upward above the supporting substrate 1, and has a trapezoidal section; two second retaining portions 1d, each of which is positioned between the slits 1b of each pair, provided by cutting raising square portions of the plate having the same widths so that they protrude upward above the supporting substrate 1, and have U-shaped sections; and vertical through holes 1e formed by providing the slits 1a and 1b, the first retaining portion 1c, and the second retaining portions 1d. As shown in FIGS. 2, 4, and 5, the first retaining portion 1c has a narrow area N located away from the second retaining portions 1d and a wide area W located closer to the second retaining portions 1d.

The single first retaining portion 1c and the two second retaining portions 1d are disposed triangularly on the supporting substrate 1. A plurality of sets, each set consisting of the three retaining portions, are formed on the supporting substrate 1.

A dust-proof sheet 2 formed of a synthetic resin is attached to the whole back face of the supporting substrate 1 by using an appropriate bonding method. The dust-proof sheet 2 may be provided so as to cover only the through holes 1e formed in the supporting substrate 1.

A contact sheet 3 composed of two layers of flexible resinous films (not shown) has printed contacts on two opposing surfaces of the resinous films disposed with a predetermined gap provided therebetween. The sheet 3 has a plurality of apertures 3a. The first retaining portion 1c and the second retaining portions 1d are mounted on the supporting substrate 1 by being inserted in the respective apertures 3a.

A link assembly L formed of a synthetic resin is constituted by a first supporting member 4 and a second supporting member 5. The first supporting member 4 is composed of: a plate-like base 4a; a round aperture 4b provided at the center of the base 4a; pivot shafts 4c installed on both sides at the center of the base 4a; a rotary shaft 4d which is provided around the pivot shafts 4c and which projects from the sidewall of one end of the base 4a; a pair of arms 4e which are provided around the pivot shaft 4c, coupled to the base 4a on the opposite side thereof, and protrude in parallel to each other; and slide retaining pins 4f provided so that they protrude inward with respect to the ends of the arms 4e.

The second supporting member 5 is constituted by a base 5a, a pair of arms 5b which are formed approximately in a U shape by being coupled to the base 5a and which are provided in parallel to each other, a slide pin 5c provided in such a manner that it protrudes outward on the free end of each of the arms 5b; a pair of pivot apertures 5d provided at the middle of each of the arms 5b such that they face each other; and a T-shaped rotary retaining pin 5e which is coupled to the base 5a and extends in the opposite direction from the arms 5b.

The first supporting member 4 and the second supporting member 5 are connected by pivot shafts 4c that are fitted from inside into the pivot apertures 5d so that they intersect with each other. The slide retaining pins 4f are slidably retained and held in the single first retaining portion 1c, and the rotary retaining pin 5e is rotatably retained and held in the two second retaining portions 1d, thus making up a set of retaining portions of the link assembly L.

A key top 6 formed of a molding of a synthetic resin has supporting portions 6a and 6b on the bottom surface thereof. The rotary shaft 4d of the first supporting member 4 and the slide pin 5c of the second supporting member 5 are retained by the supporting portions 6a and 6b, respectively.

A rubber spring 7 formed of a rubber constituent is constructed of a dome portion 7a which has a section shaped like an inverted U and a flat top surface, a cylindrical contact portion 7b provided on the top of the dome portion 7a, and a protuberance 7c provided so that it protrudes downward in the dome portion 7a. The bottom of the dome portion 7a of the rubber spring 7 is fixed onto the sheet 3 by an appropriate means, and the dome portion 7a is inserted in the round aperture 4b of the first supporting member 4 so that the contact portion 7b comes in contact with the bottom surface of the key top 6. The springiness of the dome portion 7a urges the link assembly L and the key top 6 upward at all times. At this time, the protuberance 7c provided at the bottom of the dome portion 7a is positioned above the sheet 3.

A plurality of the link assemblies L, the key tops 6, the rubber springs 7 configured as discussed above are arranged on the supporting substrate 1 and the sheet 3 to make up the keyboard apparatus. This keyboard apparatus is installed on a personal computer or the like. In using the personal computer, when the key top 6 is pressed downward against the springiness of the rubber spring 7, the link assembly L moves down with the intersecting point as its center. At this time, the slide retaining pins 4f slide in the first retaining portion 1c, while the slide pins 5c slide in the supporting portions 6b, causing the link assembly L to be collapsed. This squeezes and deforms the dome portion 7a, causing the protuberance 7c to push the contact sheet 3. The pushing force turns ON the contact provided on the sheet 3, so that the input signal of the key is transmitted to a control member (not shown) of the personal computer or the like. The moment the key top 6 is released, the deformed dome portion 7a resets itself by its own springiness, the link assembly L and the key top 6 accordingly restore their original conditions, and the contact of the sheet 3 turns OFF. In this way, the contact is turned ON/OFF.

The slide retaining pins 4f of the keyboard apparatus in accordance with the present invention are installed as follows: first, as shown in FIG. 5B, the slide retaining pins 4f are fitted to the first retaining portion 1c from above the narrow area N, which is slightly narrower than the interval between the two slide retaining pins 4f. Then, as illustrated in FIG. 5C, the slide retaining pins 4f are moved to the wide area W of the first retaining portion 1c, the wide area W being slightly wider than the interval between the two slide retaining pins 4f. In other words, the link assembly L is set back to its original state or upside so as to latch the slide retaining pins 4f to the bottom of the wide area W. This completes the installation of the slide retaining pins 4f.

The wide area W of the first retaining portion 1c has an appropriate length to prevent the slide retaining pins 4f from coming off the narrow area N by being released from the slidable engagement with the wide area W when the key top 6 is pressed to collapse the link assembly L or when the key top 6 is released and the slide retaining pins 4f slide in the first retaining portion 1c.

Thus, according to the keyboard apparatus of the present invention, the retaining portion has the narrow area and the wide area, and the slide retaining pins are latched on the wide area of the retaining portion. This permits improved assemblability of the keyboard apparatus since the slide retaining pins provided on the supporting member are attached to the retaining portion by inserting them from above the narrow area of the retaining portion in the assembly process of the keyboard apparatus.

Further, according to the keyboard apparatus of the present invention, the narrow area of the retaining portion is narrower than the interval between the slide retaining pins, while the wide area of the retaining portion is wider than the interval of the slide retaining pins. This permits easier installation of the slide retaining pins to the supporting substrate and enables the slide retaining pins to be securely held.

Moreover, according to the keyboard apparatus of the present invention, the bottom surface of the supporting substrate is provided with the dust-proof sheet to cover the apertures. This prevents adverse effect on the operation or the like of the supporting member by the intrusion of dust into the keyboard apparatus from the back face of the supporting substrate through the vertical through holes.

What is claimed is:

1. A keyboard apparatus comprising:
a supporting substrate having a retaining portion provided by cutting and raising such that it protrudes upward, and a vertical through hole resulting from the cutting and raising;
wherein a bottom surface of the supporting substrate is provided with a dust-proof sheet to cover the through hole.

2. A keyboard apparatus comprising:
a supporting substrate having a retaining portion provided by cutting and raising such that it protrudes upward, a vertical through hole resulting from the cutting and raising; and
a supporting member having a pair of slide retaining pins which are latched on the retaining portion and which protrude, opposing each other;
wherein the retaining portion has a narrow area and a wide area, and the slide retaining pins are latched in the wide area of the retaining portion.

3. A keyboard apparatus according to claim 2, wherein the narrow area of the retaining portion is formed to be narrower than the interval between the slide retaining pins, while the wide area of the retaining portion is formed to be wider than the interval between the slide retaining pins.

4. A keyboard apparatus according to claim 2, wherein a bottom surface of the supporting substrate is provided with a dust-proof sheet to cover the hole.
